(19) United States
(12) Patent Application Publication
(10) Pub. No.: US 2006/0244951 A1
(43) Pub. Date: Nov. 2, 2006

(54) Autocorrelation Technique Based on Measurement of Polarization Effects of Optical Pulses

(75) Inventors: Ting Luo, San Jose, CA (US); Changyuan Yu, Singapore (SG); Zhongqi Pan, Lafayette, LA (US); Lianshan Yan, Chino, CA (US); Saurabh Kumar, Los Angeles, CA (US); Alan E Willner, Los Angeles, CA (US)

Correspondence Address: Ting Luo, 4866 Rio Vista Ave., San Jose, CA, 95129, US

(73) Assignee: University of Southern California, Los Angeles, CA (US)

(21) Appl. No.: 11/308,049

(22) Filed: Mar. 3, 2006

Related U.S. Application Data
(60) Provisional application No. 60/659,026, filed on Mar. 4, 2005.
(60) Provisional application No. 60/659,853, filed on Mar. 8, 2005.

(51) Int. Cl. G01J 1/00

(52) U.S. Cl. 356/213

(57) ABSTRACT

Autocorrelation technique for measurement of width of optical short pulses based on polarization effects. The optical pulse is split into two orthogonal polarization states and these two replicas have a relative delay which depolarizes the pulse. By tuning the relative delay of the two replicas and measuring the degree-of-polarization (DOP) of the pulse or the induced polarimetric four-wave mixing (FWM) through nonlinear media, the pulse's temporal width can be accurately derived. The technique can be all-fiber-based, wavelength independent, cost effective, applicable to low optical power, and does not require significant optical alignment.

### CROSS-REFERENCE TO RELATED APPLICATIONS

U.S. Patent Documents:

| | | |
|---|---|---|
| 6956652 | 2005-10-18 | Whitbread et al. |
| 6847453 | 2005-01-02 | Bush et al. |
| 6819428 | 2004-11-16 | Ogawa et al. |

### OTHER REFERENCES

S. M. Reza Motaghian Nezam, et al, Journal of Lightwave Technology, Vol. 22, No. 3, pp 763-772, 2004
K. S. Chiang, et al, “Polarimetric four-wave mixing in a single-mode fiber,” IEEE Photonics Technology Lett., vol. 13, no. 8, pp 803-805, 2001

L.-S. Yan, et al “Programmable group delay module using binary polarization switching,” IEEE J. Lightwave Technol., vol. 21, no. 7, pp. 1676-1684, 2003

Parent Cast Text

This Application claims the benefit of U.S. Provisional Application No. 60/659,026 and 60/659,853 filed Mar. 4, 2005, the entire disclosure of which is incorporated herein by reference as part of this application.

### BACKGROUND OF THE INVENTION

High-speed optical communication systems in R&D facilities around the world have been steadily progressing to ever-higher data rates per channel, with 40-Gbit/s data rates the norm and state-of-the-art high-speed research being 160 Gbit/s. Many systems at 40-Gbit/s and nearly all systems above that rate generate short optical pulses for the data stream. These short pulses can be generated by modulators and be in the 10-25 ps pulse-width range, whereas the higher-rate systems tend to use short-pulse lasers with a pulse width of 1-3 ps. An extremely useful tool for any high-data-rate and ultra-fast optics laboratory is an autocorrelator that can measure the optical short pulse's temporal width.

Conventional autocorrelators use second-harmonic generation (SHG) in a nonlinear crystal. A key drawback is that the operation usually requires significant alignment of the free-space optical components, and also amplification of the optical pulses to a high power level. A highly desirable laboratory tool would be an autocorrelator that is optical-fiber-based such that optical alignment requirements are minimized. And it is desired that the autocorrelation technique can be applicable to low optical power.

### BRIEF SUMMARY OF THE INVENTION

This invention includes novel autocorrelation techniques based on measurement of polarization effects of optical short pulses. The optical pulse is split into the two orthogonal polarization states and these two replicas have a relative delay which depolarizes the pulse. By tuning the relative delay of the two replicas and measuring the polarization characteristics of the pulse, the pulse's temporal width can be accurately derived.

In one embodiment, the system consists of a tunable differential-group-delay (DGD) element and a simple degree-of-polarization (DOP) meter. While travelling in the tunable DGD module, the pulse is split equally into the two principal states of polarization (PSPs). The relative delay between these two polarization states is dynamically controlled via a computer interface. DOP of the output pulse is actually proportional to the autocorrelation function of the pulse and therefore is used to obtain the pulse width of the incoming signal. By measuring the DOP as a function of induced DGD, the pulse's temporal width can be accurately derived. This scheme is cost effective, wavelength independent, applicable to low optical power, all-fiber-based, and does not require significant optical alignment of free-space optical elements.

In another embodiment, the system is composed of a tunable DGD element and a piece of highly-nonlinear fiber (HNLF). Again the incoming pulse is split into two PSPs of the tunable DGD element. The output of the tunable DGD element is then coupled with a continuous wave probe whose polarization state is aligned with one of the PSPs and enters a piece of HNLF. Due to the polarimetric four-wave mixing (FWM) effect between the two polarization states of the pulse and the probe inside the HNLF, a signal along the polarization orthogonal to the probe is generated. The power of this orthogonal signal is dependent on the overlapping of the pulse. Therefore, if we vary the relative delay of the two polarization states of the pulse and then measure the optical power of the generated signal, the pulse width can be determined. This scheme is also all-optical-fiber-based so as to minimized optical alignment.

### BRIEF DESCRIPTION OF THE SEVERAL VIEWS OF THE DRAWING

FIG. 1 shows the principle of a conventional autocorrelator based on free-space delay stage and SHG in a nonlinear crystal.

FIG. 2 shows the principle of the present invention of autocorrelation technique based on tunable delay of the two orthogonal polarization components and measurement of the polarization effects of the pulse.

FIG. 3 shows the principle of one embodiment of the present invention using a tunable DGD element and DOP measurement.

FIG. 4 shows the system setup using a tunable DGD element and DOP meter.

FIG. 5 shows DOP versus DGD for 10, 20 and 40 GHz Return-to Zero (RZ) pulses, and FIG. 6 shows DOP versus DGD for 20 and 40 GHz carrier-suppressed RZ (CSRZ) pulses.

FIG. 7 shows DOP versus DGD for 80 GHz CSRZ pulses, and FIG. 8 shows the corresponding pulse width measurement using conventional SHG autocorrelator.

FIG. 9 shows DOP versus DGD for mode-lock laser pulses, and FIG. 10 shows the corresponding pulse width measurement using conventional SHG autocorrelator.

FIG. 11 shows the principle of another embodiment of the present invention based on polarimetric FWM induced by the pulse.

FIG. 12 shows simulation results of new component power versus relative delay.

FIG. 13 shows the system setup based on based on polarimetric FWM induced by the pulse.

FIG. 14, FIG. 15 and FIG. 16 shows the measured generated component power versus the DGD value for 20 GHz, 40 GHz and 80 GHz CSRZ pulses, respectively.

### DETAILED DESCRIPTION OF THE INVENTION

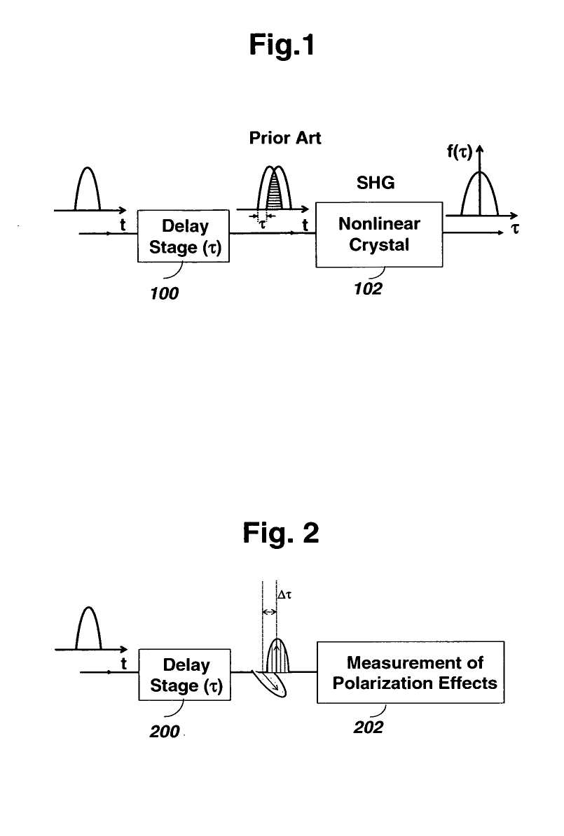

As shown in FIG. 1, in prior art, an incoming pulse is split in half by a free-space delay stage 100, with one half delayed relative to its twin. These two pulses impinge on a nonlinear crystal 102, for which a new optical signal is generated using second-harmonic generation (SHG) only where the two optical twin pulses overlap in time. The pulse width can then be derived by changing the time delay between the twin pulses. A key drawback of this typical configuration is that it requires a fair amount of alignment of the free-space optics. And the power of the input pulse should be high in order to induce nonlinear optical second-harmonic generation in the crystal.

In the present invention, as shown in FIG. 2, the optical pulse is split into the two orthogonal polarization components in a delay stage 200 and these two replicas have a tunable relative delay. The two replicas are combined after 200. By tuning the relative delay of the two replicas and measuring the polarization characteristics of the combined pulse in 202, the original pulse's temporal width can be accurately derived.

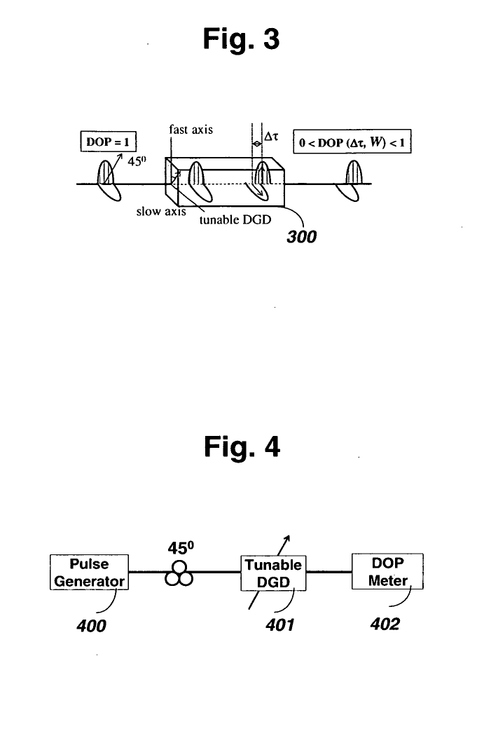

FIG. 3 shows the principle of one embodiment, which is based on DOP measurement of the pulse. A tunable DGD element 300 serves as the delay stage, and DOP of the pulse is measured to derive the width of the original pulse. An incoming polarized pulse train has a DOP of 1 and is aligned 45° with respect to the PSPs of the tunable DGD element 300. While traveling in the tunable DGD module 300, the pulse is split into the two PSPs and these two replicas have a relative delay (Δτ=dgd). When Δτ=0, the two replicas are totally overlapped so that DOP=1. As Δτ increases, this overlap decreases, so the pulse's twin replicas on the two PSPs become more depolarized. Therefore, DOP is decreased at the output of the DGD element. When Δτ exceeds the pulse width, the DOP will reach its minimum. The DOP of the depolarized pulse is dependent on both the DGD delay (Δτ) and the pulse shape. The output DOP is:
DOP(dgd)=Abs((Rᵢₙ(dgd)+Rᵢₙ(−dgd))/(2*Rᵢₙ(0)))=Abs(Rᵢₙ(dgd)/Rᵢₙ(0)) (1)

where Rᵢₙ is the autocorrelation function of the pulse.

Therefore, if we sweep the relative delay by tuning DGD, which is dynamically controlled via a computer interface, the trace of the measured DOP versus DGD will emulate the autocorrelation function of the pulse and then the pulse width W can be derived using the following formula:
W=FWHM*constant (2)

where W is the pulse width, FWHM is the full-width at half-maximum of the trace of DOP versus DGD, and the constant is the autocorrelation scale factor depending on the shape of the pulse. This scheme is all-fiber-based, wavelength independent, cost effective, applicable to low optical power, and does not require significant optical alignment.

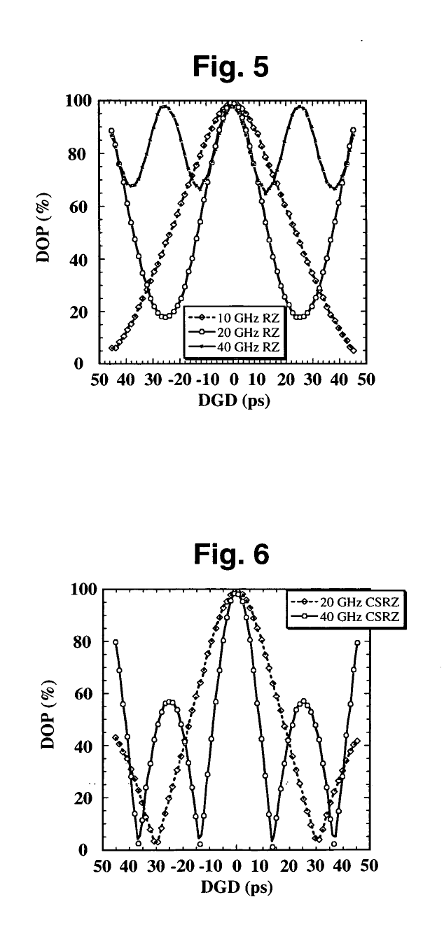

As shown in FIG. 4, the system setup is simple and has only 3 components: a 45° polarization controller (PC) 401, a tunable DGD element 402 and a DOP meter 403. In the demonstration, the tunable DGD module 402 provides sweeping of DGD ranging from −45 ps to 45 ps. It consists of 6 multiple switch/delay sections. Each section has a birefringent crystal and a magnetooptic polarization switch. Based on fast polarization switching, which is controlled via a computer interface, it can generate any DGD value from −45 ps to 45 ps in <1 ms with a resolution of ˜1.4 ps. Note that the resolution of the autocorrelator will increase with the increase of the resolution of the tunable DGD element. The DOP of the depolarized pulse is then measured by a DOP meter. Since the DOP meter can handle optical power as small as −50 dBm, no amplifiers are needed in the setup.

In the demonstration experiment, first the pulse widths are measured for 10 GHz, 20 GHz, 40 GHz RZ pulse trains, and 20 GHz, 40 GHz CSRZ pulse trains using both our technique and oscilloscope. The autocorrelation scale factors of RZ and CSRZ shape pulses are derived by calibration of using these two measurements. The 10 GHz, 20 GHz and 40 GHz RZ pulse trains are generated by modulation of 10 GHz, 20 GHz and 40 GHz clocks, respectively. As shown in FIG. 5, the FWHM of the traces of autocorrelator are 47.0 ps, 22.6 ps and 12.6 ps for 10 GHz, 20 GHz and 40 GHz RZ pulse, respectively. The pulse widths of them are measured to be 43 ps, 23 ps and 12.5 ps, respectively, from the oscilloscope. Therefore, the autocorrelation scale factor of RZ pulse is 1. The 20 GHz and 40 GHz CSRZ pulse trains are generated by biased modulation of 10 GHz and 20 GHz clocks. As shown in FIG. 6, the FWHM of the traces of autocorrelator are 34.3 ps and 17.8 ps for 20 GHz and 40 GHz CSRZ pulse, respectively. The pulse widths of them are 24 ps and 13 ps on the oscilloscope, respectively. The autocorrelation scale factor of CSRZ pulse is calibrated to be 0.71.

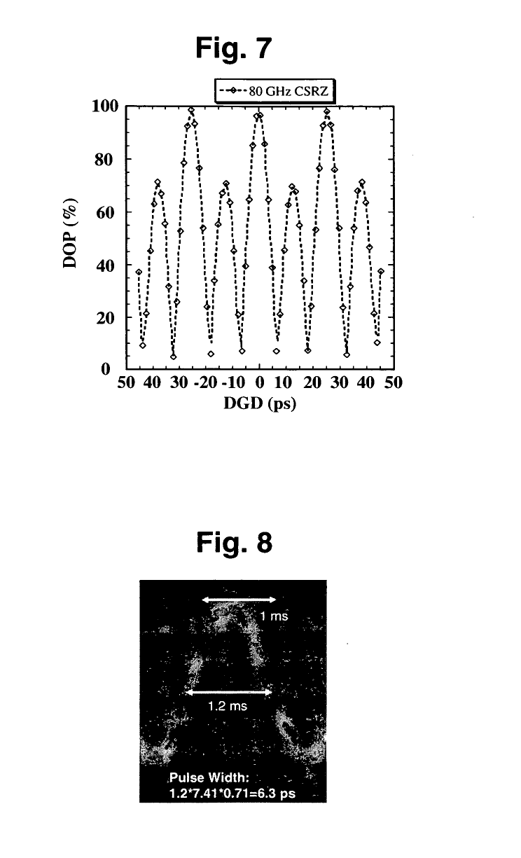

Then the measurement are demonstrated for the pulse widths of an 80 GHz CSRZ pulse train and a pulse train from a mode-lock laser source, which are not visible by a conventional oscilloscope. The 80 GHz CSRZ pulse is generated from a biased modulation of a 40 GHz clock signal. FIG. 7 shows the trace of DOP versus DGD. The FWHM of the trace is measured to be 8.8 ps. After multiplying the scale factor of CSRZ calculated above, the pulse width is calculated to be 6.3 ps. For comparison, FIG. 8 shows the measurement of the pulse width using the conventional SHG method. The conventional autocorrelator we used has a scale factor of 7.41 ps/ms. By using the shape factor of 0.71, the measured pulse width is also 6.3 ps. The two measured results are consistent.

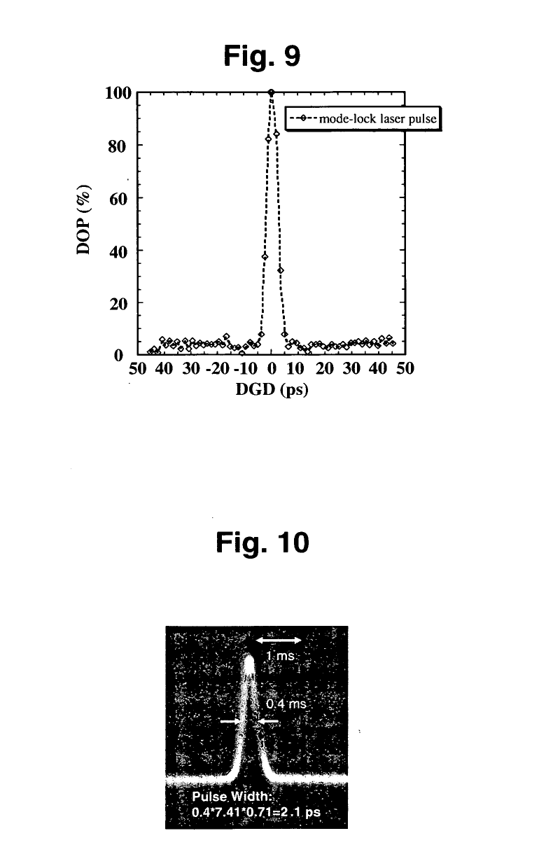

FIG. 9 is the experimental measurement of the pulse train from a mode-lock laser source. The FWHM of the trace is measured to be 3.3 ps. Using the Gaussian pulse scale factor, the pulse width is calculated to be 2.3 ps. FIG. 10 is the measurement of the mode-lock laser pulse using the conventional SHG autocorrelator. The pulse width is measured to be 2.1 ps. Again, the measurement using the new invented technique agrees very well with the conventional technique. Note that the measurement accuracy can be increased by improving the resolution of the DGD element.

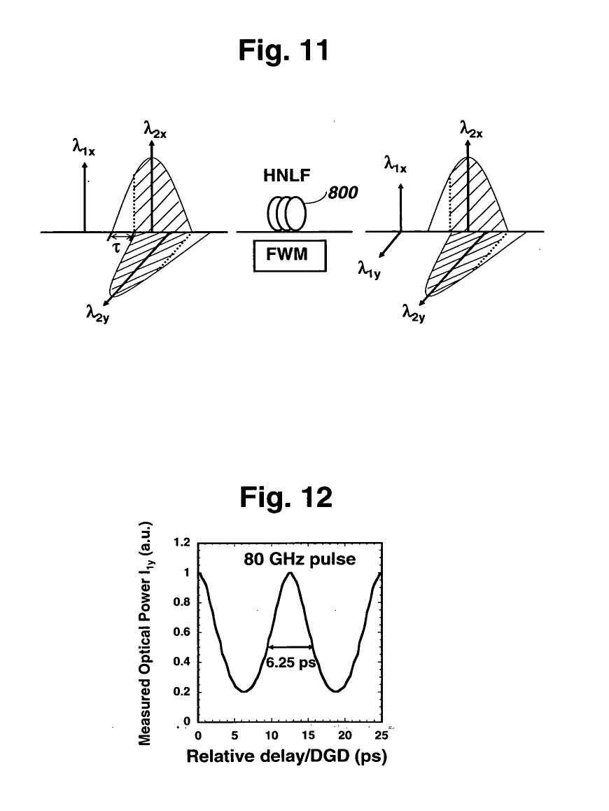

FIG. 11 shows the principle of another embodiment, which is based on polarimetric FWM induced by the pulse. When the two polarization states of the pulse have a relative delay of τ, (e.g. after passing through the tunable DGD element), the power of the overlapping components of the pulse along x and y polarization states are functions of the delay τ, which can be represented as I₂ₓ(τ) and I_{2y}(τ), respectively. If the pulse is coupled with a continuous wave which is polarized along the x direction and launched into a HNLF 800, these three polarization components will interact with each other and generate a fourth component along y direction at the wavelength of λ₁ due to FWM effect. The power of the generated component is dependent on the delay τ and can be represented as:
I_{1y}(τ)=(16/9)*(2*pi/λ₁)^{2*}(n₂/A_{eff})^{2*}I₁ₓ(τ)I₂ₓ(τ)I_{2y}(τ)L² (3)

where n₂ is the intensity nonlinear coefficient of the fiber, A_{eff} is the effective area of the fiber core, and L is the fiber length. Therefore, by sweeping the relative delay of the two polarization components of the pulse, the optical power of the generated new orthogonal component at wavelength λ₁ will change accordingly and the pulse width can thus be derived from this trace. An example of the relationship between the generated new component power and the relative delay between the two pulse components is shown in FIG. 12. This scheme is again all-optical-fiber based so that the alignment of free space optical components is minimized, though the requirement of the power of the pulse is relatively high compare to the DOP measurement.

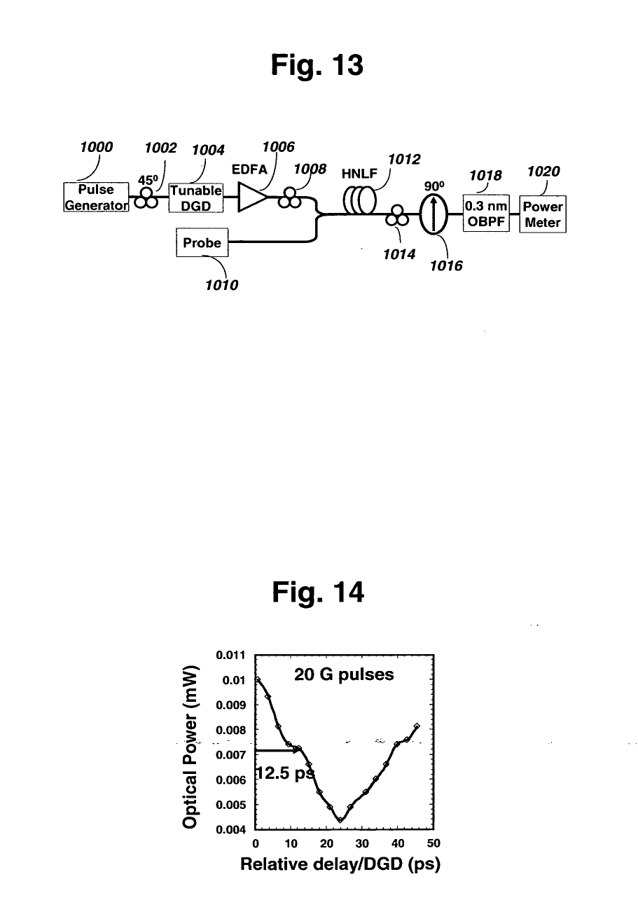

FIG. 13 shows the system setup. The relative delay of the two polarization components of the pulse is again provided by a dynamically tunable DGD module 1004 controlled via a computer interface. It generates any DGD value from −45 ps to 45 ps in <1 ms with a resolution of ˜1.4 ps. The pulse under test (PUT), which is at wavelength 1551.04 nm, is aligned 45° by polarization controller 1002 with respect to the principal states of the tunable DGD element. After going through the DGD module 1004, it is boosted by an erbium-doped fiber laser (EDFA) 1006 and then combined with a probe laser 1010 which is at the wavelength of 1565.1 nm. The combined beam is then launched into a 2 km HNLF 1012, whose zero-dispersion wavelength is ˜1552 nm. The dispersion slope and nonlinear coefficient γ of the HNLF for the demonstration are 0.045 ps/(nm²·km) and 9.1/(W·km), respectively. Note that the performance of the autocorrelator will be better with a nonlinear fiber with higher nonlinear coefficient. At the output of the HNLF, a polarizer 1016 is used to obtain the optical component along y direction (the direction orthogonal to the original probe polarization). A 0.3 nm filter 1018 centered at the probe wavelength 1565.1 nm and followed by a power meter 1020 is placed after the polarizer to measure the power of the new generated optical component.

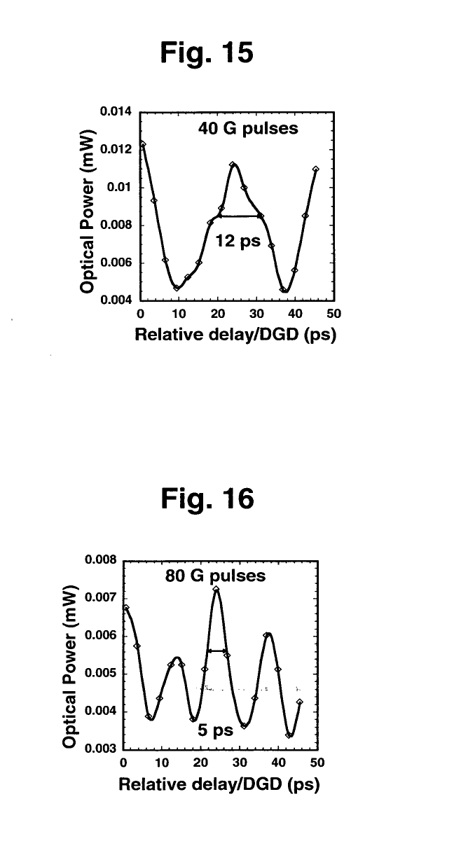

For demonstration, 20 GHZ, 40 GHz, and 80 GHz CSRZ pulse widths are measured by both this new scheme and conventional method. The DGD element sweeps from 0 ps to 45 ps with the resolution of 1.4 ps. The polarization of the pump is adjusted using the polarization controller after the EDFA in order to align one of its polarization components to the probe. FIG. 14, FIG. 15 and FIG. 16 shows the measured generated component power versus the DGD value for 20 GHz, 40 GHz and 80 GHz CSRZ pulses, respectively. The measured full-width at half-maximum (FWHM) of the trace is 25 ps, 12 ps and 5 ps, respectively. The real pulse width is then calculated by:
Pulsewidth=FWHM*constant (4)

where the constant is the autocorrelation scale factor depending on the shape of the pulse. The 20 GHz pulse width measured from the conventional method is 25 ps. Therefore, the scale factor is 1. Then it can be calculated that the 40 GHz pulse is 12 ps, and the 80 GHz pulse width is 5 ps, which agree well with the measurement results from the conventional method, which are 11.8 ps and 7.7 ps respectively.

Only a few embodiments are disclosed. However, it is understood that variations and enhancements may be made without departing the spirit of and are intended to be encompassed by our claims.

What is claimed is:

1. A device, comprising: a dynamic polarization controller and a tunable differential group delay element followed by a degree-of-polarization meter to form an optical path to measure the pulse width of the input optical signal.

2. The device as in claim 1, wherein the dynamic polarization controller is used to align the input polarization state of the optical pulse to 45-degree of the said differential group delay element.

3. The device as in claim 1, wherein the differential group delay element is used to separate the input optical signal into two orthogonal polarization states and to be tuned to generate desired delay between the said two polarization states.

4. The device as in claim 1, wherein the degree-of-polarization meter is used to measured the final degree-of-polarization after the optical pulse passing through the said differential group delay element.

5. A method, comprising:
causing the optical pulse for measurement to be separated into two orthogonal polarization states through said dynamic polarization controller and differential group delay element;
causing a tunable differential group delay element to introduce the desired pulse overlapping between two said orthogonal polarization states;
causing the degree-of-polarization through the said differential group delay element to be reduced to a corresponding value depending on the differential group delay value;
causing the degree-of-polarization meter to measure the overall degree-of-polarization to obtain the pulse width of the input optical signal.

6. A method as claimed in 5, further comprising: in controlling the input polarization state, introducing different amounts of differential group delay and measuring the degree-of-polarization values.

7. An arrangement for optical autocorrelation, that can measure the optical pulse width, comprising: a polarization controller, a tunable DGD element, a continuous optical probe wave, highly-nonlinear fiber HNLF, and a optical power meter.

8. The arrangement according to claim 7 in which the dynamic polarization controller is used to align the input polarization state of the optical pulse to 45-degree of the said differential group delay element.

9. The arrangement according to claim 7 in which the DGD element is used to separate the input optical signal into two orthogonal polarization states and to be tuned to generate desired delay between the said two polarization states.

10. The arrangement according to claim 7 in which a continuous optical probe wave is aligned to 45 degree of DGD element and is used to mix with the input signal in the highly-nonlinear fiber HNLF.

11. The arrangement according to claim 7 in which the highly-nonlinear fiber is used to mix the probe and the input signal to generate a new signal.

12. The arrangement according to claim 7 in which the optical power meter is used to measure the generated new signal.

13. The arrangement according to claim 7, wherein the FWM effect between the two polarization states of the signal pulse and the probe wave inside the HNLF generates a new signal along the polarization orthogonal to the probe. The generated signal power is a function of the DGD and the input pulse width; therefore the power function can be used to derive the width of the input optical pulse.
